(19) United States
(12) Patent Application Publication
(10) Pub. No.: US 2024/0418112 A1
(43) Pub. Date: Dec. 19, 2024

(54) Method for Operating an Internal Combustion Engine, a System for Carrying Out the Method and an Internal Combustion Engine

(71) Applicant: KEYOU GmbH, München, DE (US)

(72) Inventors: Franz Werner Prümm, Unterschleissheim (DE); Daniel Koch, Unterschleissheim (DE)

(21) Appl. No.: 18/709,063

(22) PCT Filed: Nov. 11, 2022
(86) PCT No.: PCT/EP2022/081601

§ 371 Date: May 10, 2024

(30) Foreign Application Priority Data
Nov. 12, 2021 (DE) 10 2021 129 506.8

(51) Int. Cl. F01N 3/08

(52) U.S. Cl. CPC F01N 3/0814; F01N 3/0842; F01N 13/011; F02D 19/024; F01N 2250/12; F01N 2610/04

(57) ABSTRACT

The invention relates to a method for operating an internal combustion engine, wherein the internal combustion engine includes at least one combustion chamber in which a fuel is at least partially burned with ambient air, an exhaust tract that is coupled to an outlet side of the at least one combustion chamber in a fluid communicating manner, wherein hydrogen is used as fuel for the internal combustion engine, wherein the internal combustion engine also has at least one NOx storage catalyst and an exhaust gas discharged from the at least one combustion chamber into the exhaust tract at least partially, preferably entirely, flows through the at least one NOx storage catalyst, wherein a lean hydrogen-air mixture is burned in the at least one combustion chamber in a first operating state, wherein the NOx storage catalyst is regenerated in a second operating state. In order to easily operate the internal combustion engine as a low-emissions system, a rich hydrogen-air mixture is burned in the at least one combustion chamber in the second operating state.

### CROSS-REFERENCE TO RELATED APPLICATIONS

This application is the United States national phase of International Patent Application No. PCT/EP2022/081601 filed Nov. 11, 2022, and claims priority to German Patent Application No. 10 2021 129 506.8 filed Nov. 12, 2021, the disclosures of each of which are hereby incorporated by reference in their entireties.

### BACKGROUND OF THE INVENTION

### Field of the Invention

The present invention relates to a method for operating an internal combustion engine, a system for carrying out the method and an internal combustion engine.

### Description of Art

It is known that hydrogen-powered internal combustion engines are preferred in terms of emissions. For example, carbon-containing emission products such as soot and carbon monoxide are eliminated in these internal combustion engines.

Furthermore, DE10 2016 107 466 A1 proposed a selective catalytic reduction for the reduction of NOx components in exhaust gases from hydrogen-powered combustion engines. However, a reduction agent must be continuously fed into the exhaust tract. This requires a fine dosing of the reduction agent with a continuous control requirement, wherein NOx emissions can be released into the atmosphere if it fails.

JP 2006 057504 discloses a method in which an internal combustion engine is operated with hydrogen. A NOx storage catalyst, which stores nitrogen oxides produced during combustion, is located in the exhaust tract of the internal combustion engine. Fossil fuel is added to the combustion mixture to regenerate the NOx storage catalyst.

US 2004/055 281 A1 and EP 1 754 874 A1 each disclose a method. EP 1 319 813 A2 discloses a method.

### SUMMARY OF THE INVENTION

Regeneration requires difficult control, in addition, several fuels are involved in the formation of the combustion mixture, which makes the system and combustion complicated.

The problem underlying the present invention is therefore to operate an internal combustion engine in a simple and robust manner as a zero-/low-emission system.

This problem is solved by a method for operating an internal combustion engine as described herein.

According to a first aspect, a method for operating an internal combustion engine is provided, in which the internal combustion engine comprises: at least one combustion chamber in which a fuel is at least partially burned with ambient air; an exhaust tract that is coupled to an outlet side of the at least one combustion chamber in a fluid communication manner. Hydrogen is used as fuel for the internal combustion engine. The internal combustion engine also has at least one NOx storage catalyst and an exhaust gas discharged from the at least one combustion chamber into the exhaust tract at least partially, preferably entirely, flows through the at least one NOx storage catalyst. In a first operating state, a lean air/hydrogen mixture is burned in the at least one combustion chamber. In a second operating state, the NOx storage catalyst is regenerated, with a rich air/hydrogen mixture being burned in the at least one combustion chamber in the second operating state.

According to the first aspect, the internal combustion engine has at least one NOx storage catalyst through which the discharged exhaust gas flows. This allows nitrogen oxide (NOx) emissions to be stored in said NOx storage catalyst, which is also referred to as an LNT catalyst. This eliminates the need for a continuous supply of reduction agents.

The first aspect makes use of synergy effects resulting from the fact that hydrogen is used as fuel for the combustion engine. Combustion engines operated in this way only produce thermal nitrogen oxides as harmful combustion products. Other devices for exhaust gas aftertreatment can therefore be omitted. Accordingly, there is space available in the exhaust tract for an appropriately dimensioned NOx storage catalyst.

Furthermore, the process conditions such as the combustion temperature of a hydrogen-powered combustion engine result in low nitrogen oxide formation compared to diesel engines, for example. This means that nitrogen oxides can be reliably stored in the NOx catalyst over a long period of time.

Furthermore, in the method, a lean air/hydrogen mixture is burned in the at least one combustion chamber in a first operating state.

By burning a lean mixture, the efficiency of the combustion engine can be increased. At the same time, the combustion temperatures can be reduced, which further inhibits the formation of nitrogen oxides and thus allows the NOx storage catalyst to store nitrogen oxides over a long period of time. In this process, the combustion of the lean mixture is preferably operated continuously, thus over a plurality of cycles of the combustion engine. A lean air/hydrogen mixture is a super-stoichiometric mixture. Preferably, a λ of greater than or equal to 1 and less than or equal to 5 is set; depending on the operating point, a λ of greater than or equal to 1.3 and less than or equal to 3.5 is particularly preferred.

In addition, the NOx storage catalyst is regenerated in a second operating state.

The nitrogen oxide stored in the NOx storage catalyst can be converted into atmospheric nitrogen and released into the atmosphere. The NOx storage catalyst can then absorb nitrogen oxides again. In this way, a continuous discharge of harmful emissions can be prevented.

According to the invention, in the second operating state, a rich air/hydrogen mixture is burned in the at least one combustion chamber.

In the second operating state, a sub-stoichiometric air/hydrogen mixture can therefore be fed to the combustion chamber. Preferably, a λ of greater than or equal to 0.6 and less than or equal to 1.0 is set, particularly preferably greater than or equal to 0.8 and less than or equal to 0.9. On the one hand, a rich air/hydrogen mixture can reduce, preferably completely prevent, the formation of nitrogen oxide due to a lack of oxygen, and on the other hand, it can ensure that unburned hydrogen is fed to the exhaust tract as a reduction agent. This means that the excess hydrogen can be used to regenerate the NOx storage catalyst.

The rich mixture can be set in appropriate situations due to the low nitrogen oxide formation and the associated long storage possibility.

Preferably, the internal combustion engine also has an exhaust gas recirculation device that returns exhaust gas from the exhaust tract to the combustion chamber.

This allows inert components of the combustion product to be recirculated from the exhaust tract into the combustion chamber. These components no longer take part in the combustion and extract exothermic energy from the combustion process. The process temperature can thus be reduced, which inhibits the formation of further nitrogen oxide. Preferably, the exhaust gas is recirculated as high-pressure exhaust gas, in particular from a position upstream of a turbine in the exhaust tract. This ensures a sufficient recirculation volume.

According to yet another aspect, in the second operating state, exhaust gas can be recirculated into the at least one combustion chamber via the exhaust gas recirculation device.

Thus, in the second operating state for the regeneration of the NOx storage catalyst, the formation of further nitrogen oxide can be reduced, preferably completely prevented, and the regeneration of the storage catalyst can be carried out reliably. Another preferred effect occurs in particular in conjunction with hydrogen, as the less reactive mixture can prevent a tendency to pre-ignition, that is, early ignition.

Preferably, the second operating state is set in an idling operation of the combustion engine.

In this way, the effects of regeneration operation on the behavior of the device driven by the combustion engine can be prevented. In particular, in motor vehicles with a hydrogen-powered internal combustion engine, effects on driving behavior can be prevented. As already mentioned, the second operating state can be carried out in appropriate situations, such as standing at a traffic light, thus, in particular when the internal combustion engine is operated without performing the work predetermined for it, for example, by being disconnected from at least one drive wheel of a vehicle, or in other words no load is applied to the internal combustion engine. As such situations are sufficiently likely to occur when the internal combustion engine is used in a motor vehicle, the operation of the motor vehicle is not limited by necessary regeneration phases of the catalyst. Furthermore, by throttling the amount of air supplied performed in idling, high rates of exhaust gas recirculation can be achieved. This is due to the fact that the exhaust gas back pressure (upstream of the turbine of a possible exhaust gas turbocharger) is greater than the pressure in the intake manifold in this state. Thus, the above effects of exhaust gas recirculation can be reliably achieved in the regeneration mode.

According to some embodiments, the second operating state can be set in an overrun operation of the internal combustion engine. The overrun operation is characterized in particular in that the power generated by the internal combustion engine is less than the dragging power applied to the internal combustion engine. In other words, the internal combustion engine can be kept rotating from the output side.

In this case, too, the operation of a motor vehicle is not limited by the necessary regeneration phases of the catalyst, as overrun operation of the combustion engine is also sufficiently likely to occur during long journeys. While the amount of air supplied is throttled in idling mode, in overrun operation the amount of fuel supplied can be set specifically so that a rich mixture is burned. At the same time, ignition can take place very late, which stabilizes combustion and thus reduces or preferably prevents the formation of further nitrogen oxides. Preferably, ignition takes place in a range from a maximum of 40° before the top dead center of a crankshaft angle to the opening of an exhaust valve, in particular in an angular range of a crankshaft from a maximum of 40° before to a maximum of 360° after the top dead center, further preferably from a maximum of 20° before to a maximum of 360° after the top dead center, again preferably from a maximum of an angle corresponding to a top dead center to a maximum of 360° after the top dead center.

The rich mixture and late ignition can increase the exhaust gas enthalpy, which ensures a sufficient temperature for catalyst regeneration. The power generated by the combustion engine in overrun operation is less than the applied dragging power so that overrun operation can be maintained. Carrying out the combustion of a rich mixture as a regeneration mode in the overrun phase has the advantage that the transition from the lean to the rich mixture range can take place discontinuously and thus a mixture range around A equal to 1 does not have to be traversed. The formation of nitrogen oxides is usually very high in this range.

Preferably, exhaust gas is recirculated at least temporarily in a transition between the first operating state and the second operating state.

Thus, even in a case in which a mixture close to the stoichiometric ratio is traversed in the transition, the formation of nitrogen oxides can be reduced, preferably completely prevented.

According to some embodiments disclosed herein, which can be provided or as an aspect dependent on the first aspect, a method for operating an internal combustion engine is provided, wherein the internal combustion engine has at least one combustion chamber, in which a fuel is at least partially burned with ambient air, and an exhaust tract, which is coupled to an outlet side of the at least one combustion chamber in a fluid communicating manner. Hydrogen is used as fuel for the internal combustion engine, wherein the internal combustion engine also has at least one NOx storage catalyst and an exhaust gas discharged from the at least one combustion chamber into the exhaust tract at least partially, preferably entirely, flows through the at least one NOx storage catalyst, wherein a lean air/hydrogen mixture is burned in the at least one combustion chamber in a first operating state, wherein in a second operating state the NOx storage catalyst is regenerated, wherein in the second operating state a reduction agent for reducing the nitrogen oxides stored in the NOx storage catalyst is fed as part of the exhaust gas into the at least one combustion chamber, or downstream of the at least one combustion chamber upstream of the NOx storage catalyst or into the NOx storage catalyst into the exhaust tract.

According to this aspect, too, only thermal nitrogen oxides are produced as harmful combustion products during the combustion of the lean air/hydrogen mixture. Other exhaust gas aftertreatment devices can therefore be omitted. Accordingly, space is available in the exhaust tract for an appropriately dimensioned NOx storage catalyst.

Furthermore, the process conditions such as combustion temperature of a hydrogen-powered internal combustion engine operated lean and/or with a high exhaust gas recirculation rate result in low nitrogen oxide formation compared to diesel engines, for example. This means that nitrogen oxides can be reliably stored in the NOx catalyst over a long period of time.

The combustion of a lean mixture can increase the degree of efficiency of the combustion engine. At the same time, the combustion temperatures can be reduced, which further inhibits the formation of nitrogen oxides and thus allows the NOx storage catalyst to store nitrogen oxides over a long period of time. In this process, the combustion of the lean mixture is preferably operated continuously, thus over a plurality of cycles of the combustion engine. A lean air/hydrogen mixture is a super-stoichiometric mixture. Preferably, a λ of greater than or equal to 1 and less than or equal to 5 is set; depending on the operating point, a λ of greater than or equal to 1.3 and less than or equal to 3.5 is particularly preferred.

In addition, the NOx storage catalyst is regenerated in a second operating state.

The nitrogen oxide stored in the NOx storage catalyst can be converted into atmospheric nitrogen and released into the atmosphere. The NOx storage catalyst can then absorb nitrogen oxides again. In this way, a continuous discharge of harmful emissions can be prevented.

Furthermore, according to this aspect, the reduction agent can be fed directly into the exhaust tract without having to be provided as exhaust gas from a combustion process. Thus, the internal combustion engine can continue to be operated in the first operating state of burning a lean air/hydrogen mixture. In particular, a lean air/hydrogen mixture can continue to be burned. The first and second operating states are therefore not mutually exclusive, but can also coexist. Of course, the direct supply of a reduction agent into the exhaust tract can also take place alongside the combustion of a rich mixture, so that only the second operating state is then present.

According to this aspect, however, it is also possible, particularly in internal combustion engines that feed the fuel directly into the combustion chamber, to provide the reduction agent as part of the exhaust gas. In this case, the reduction agent can be fed into the combustion chamber and then fed to the exhaust tract after being discharged from the combustion chamber.

Preferably, a rotational or divergent component is impressed to the flow of the supplied reduction agent, at least in sections.

This can increase the mixing in the exhaust tract and the storage catalyst can be reliably regenerated, as the reduction agent flows through it evenly.

Preferably, the reduction agent is hydrogen and particularly preferably comes from the same source as the hydrogen used as fuel. In particular, if the reduction agent is injected directly into the combustion chamber, the same feeding device that is used to feed the hydrogen into the combustion chamber can be used.

This reduces the complexity of the system, as all components can be adapted to hydrogen. Furthermore, there is no need for an additional storage device such as a tank for the reduction agent.

Preferably, the reduction agent is fed into the combustion chamber after completion of a combustion process, further preferably during an exhaust stroke in which the exhaust gas is discharged from the combustion chamber. This ensures that the reducing agent is not burned with the oxygen in the air contained in the combustion chamber.

According to a further aspect, the setting of the second operating state can be carried out at a degree of saturation of the NOx storage catalyst of greater than 20% or less than 100%, preferably 70-90%, particularly preferably 80%. Known methods for determining the degree of saturation can be used.

This means that the storage catalyst can be used for a large part of its storage capacity. Due to the low nitrogen oxide formation in the first operating state, oversaturation can be prevented during the switchover so that the switchover can take place very close to the storage capacity limit.

According to still a further aspect, which can be provided as a further independent aspect or can be provided as an aspect dependent on the above aspects, a method for operating an internal combustion engine is provided, wherein the internal combustion engine has at least one combustion chamber, in which a fuel is at least partially burned with ambient air, and an exhaust tract, which is coupled to an outlet side of the at least one combustion chamber in a fluid communicating manner, wherein hydrogen is used as fuel for the internal combustion engine. The exhaust tract has a plurality of exhaust tract sections connected in parallel, wherein at least two of the plurality of exhaust tract sections each have at least one NOx storage catalyst through which at least a portion of an exhaust gas discharged from the at least one combustion chamber into the exhaust tract flows at least temporarily, wherein the flow rate through the at least one NOx storage catalyst is at least temporarily changed in at least one of the exhaust tract sections, preferably by a variable throttle device arranged upstream of the at least one NOx storage catalyst.

The flow of the exhaust gas can thus be influenced depending on the residual capacity of the at least one NOx storage catalyst. If the NOx storage catalyst in an exhaust tract is close to the capacity limit, the flow rate in this exhaust tract can be reduced, while NOx storage catalysts connected in parallel can continue to be flown through by larger amounts. This also allows the NOx storage catalyst to be operated efficiently, as in the above aspects.

The flow rate in a plurality of the exhaust tract sections, each having the at least one NOx storage catalyst, is changed independently of one another.

For this purpose, a variable throttle device is arranged in a plurality of the plurality of exhaust tract sections arranged parallel to one another upstream of the at least one NOx storage catalyst, the variable throttle device being individually controlled to regulate the exhaust gas amount in the respective exhaust tract section.

Thus, it is possible to react independently to each NOx storage catalyst connected in parallel.

Furthermore, to regenerate the at least one NOx storage catalyst, the flow rate in at least one of the exhaust tract sections can be reduced, preferably completely suppressed.

If the internal combustion engine is operated with a lean combustion mixture, for example, nitrogen oxides would continue to flow through the at least one exhaust tract section with the NOx storage catalyst near the capacity limit in an unthrottled state. The reduction can thus suppress a further strong supply of nitrogen oxides in the at least one of the exhaust tract sections during regeneration.

A reduction agent for reducing the nitrogen oxides stored in the NOx storage catalyst is fed into at least one, particularly preferably each, of the plurality of exhaust tract sections connected in parallel to one another upstream of the at least one NOx storage catalyst or into the at least one NOx storage catalyst, and particularly preferably the amount of reduction agent fed is controlled individually for each exhaust tract section.

This can increase the efficiency of NOx storage and regeneration. The internal combustion engine can continue to be operated with a lean combustion mixture. If only a single exhaust tract is provided in this method, a considerable amount of reduction agent (hydrogen) must be added to compensate for the oxygen present due to the lean combustion. Only then can regeneration take place in the absence of oxygen. In contrast, by the above aspect, the oxygen supply in the at least one respective exhaust tract section can be reduced, for example by the throttling device, whereby a smaller amount of hydrogen is required compared to the case in which only one exhaust tract section is provided, even if the internal combustion engine continues to be operated with a lean combustion mixture. The separate feed of reduction agent into the respective exhaust tract section is therefore particularly preferred if, for regeneration, the flow rate in the respective exhaust tract section is reduced compared to a non-regeneration state such as the unthrottled state.

According to a further aspect, at least two of the exhaust tract sections can be regenerated alternately, at least temporarily.

For example, the highest increase in efficiency results in the case of two storage catalysts connected in parallel when the internal combustion engine is operated at a maximum of half its maximum output. This is because in this case, the throttle device of an exhaust tract section can be controlled, at least for the regeneration of the storage catalyst arranged therein, in such a way that it completely blocks the exhaust gas feed in this exhaust tract section, the at least one of whose storage catalysts is to be regenerated. In the parallel exhaust tract section, the throttle device is preferably controlled so that it is fully open. This means that regeneration takes place alternately in two of the exhaust tract sections, wherein regeneration takes place in one exhaust tract section and not in the other. Likewise, the change in the flow rate compared to a reference state such as the non-regeneration state, in particular the reduction, can take place alternately.

Particularly preferably, the respective throttle devices are alternately fully opened and closed during operation of the internal combustion engine up to half of the maximum output, thus the respective flow rates are alternately fully suppressed and not reduced. Preferably, the flow rates are alternately reduced up to one times the rated output minus the reciprocal of the number of exhaust tract sections arranged in parallel times the rated output, in particular completely suppressed and not reduced.

According to a further aspect, at least the storage catalysts connected in parallel, preferably the entire exhaust tract sections in each case, can be configured in such a way that the nitrogen oxides produced at maximum output can be completely stored in the unthrottled state of all exhaust tract sections, thus when the flow rate is not reduced, in particular the sum of all storage catalysts connected in parallel is configured according to a predetermined space velocity. Preferably, the storage catalysts and exhaust tract sections are identically dimensioned.

However, it is also conceivable to configure at least the storage catalysts connected in parallel, preferably the entire respective exhaust tract section, in such a way that the flow rate can be completely suppressed at rated power in at least one exhaust tract section. The flow rate can then flow at rated power through the remaining exhaust tract sections in which the flow rate is not reduced and the storage catalysts arranged therein. This ensures that nitrogen oxide generated even at rated output is stored in the storage catalysts of the exhaust tract sections that are not reduced. In particular, the sum of the remaining storage catalysts connected in parallel can be configured according to the predetermined space velocity. In the case of two parallel exhaust tract sections, each of the exhaust tract sections is preferably configured in such a way that, at rated output, the nitrogen oxides arising are completely stored in the at least one storage catalyst of the exhaust tract section in which the flow rate is not reduced. This allows the map range in which complete regeneration is possible to be extended.

Furthermore, the problem is solved by a control device which is configured to carry out the method according to one of the preceding aspects.

Such a control device allows a platform in which it is installed to be operated as a low-emission system.

In addition to the control device, the present invention also relates to a program which, when executed on a computer coupled to an internal combustion engine, carries out the above method. Likewise, the present invention relates to a computer-readable storage medium on which said program is executed.

The above problem is further solved by a system for carrying out a method according to one of the above aspects, wherein the system comprises: an internal combustion engine as defined according to one of the above aspects; and a hydrogen storage device coupled to the internal combustion engine in a fluid communicating manner.

Such a system constitutes a reliable zero-/low-emission system.

Preferably, the system further comprises a control device configured to carry out the method according to one of the above aspects.

The above effects can be reliably realized by the interaction of the control device, combustion engine and storage device.

Preferably, in the system, the internal combustion engine also has at least one inflow device, via which the reduction agent can be fed into the combustion chamber or into the exhaust tract, preferably at least one inflow device for each exhaust tract section in the case of a plurality of exhaust tract sections connected in parallel.

This allows the reduction agent to be fed into the exhaust tract in the combustion engine via the combustion chamber or bypassing the combustion chamber, so that a mixture switch from a lean mixture to a rich mixture is not necessary.

Preferably, in the system, the internal combustion engine is further configured to impress a rotational or divergent component on the flow of the reduction agent in the exhaust tract, at least in sections, wherein the internal combustion engine preferably has a turning device or a profile angled with respect to a main flow direction.

This enables improved mixing of the reduction agent in the exhaust tract, which increases the efficiency of the catalyst. The rotating component can be easily impressed by the turning device. The flow can be made divergent along this profile by means of an angled profile.

Further provided is an internal combustion engine for the system just described, which may in particular have any combination of the structural features of the present disclosure.

### BRIEF DESCRIPTION OF THE DRAWINGS

The above aspects are now explained in more detail with reference to exemplary embodiments in accordance with the Figures.

FIG. 1 schematically shows a system with which the method explained above can be carried out.

FIG. 2 shows a schematic longitudinal sectional view of a modification of an exhaust tract of an internal combustion engine according to the invention.

FIG. 3 shows a flow chart for a method for regenerating a NOx storage catalyst.

### DETAILED DESCRIPTION

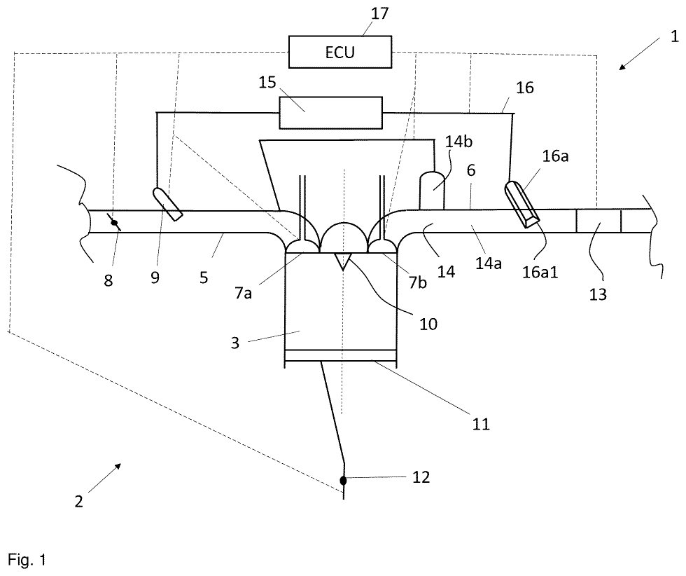

The system 1 comprises an internal combustion engine 2 (engine), which is shown in FIG. 1 in a longitudinal sectional view along an axis of a cylindrical combustion chamber 3 of the internal combustion engine 2. In addition to the combustion chamber 3, the internal combustion engine 2 has an intake manifold 5 and an exhaust tract 6, each of which is connected to the combustion chamber in a fluid communicating manner, via an inlet and outlet 7a and 7b, which are opened and closed respectively via valves.

As shown in FIG. 1, a throttle valve 8 for regulating the air amount and an injection device 9 for injecting a fuel into the intake manifold 5 can be located in the intake manifold 5. At an upper end, the combustion chamber 3 is closed by a cylinder head in which a spark plug 10 is arranged to ignite the air/fuel mixture entering the combustion chamber through the inlet 7a. At the lower end, the combustion chamber 3 is closed by a piston 11, which is rotatably coupled to a crankshaft 12. Preferably, only hydrogen is used as fuel.

The outlet 7b, through which the exhaust gas produced by burning the air/fuel mixture flows into the exhaust tract 6, is located opposite the inlet 7a in relation to the axis.

An NOx storage catalyst (NSK) 13 is located downstream of the outlet 7b in the exhaust tract 6. This NOx storage catalyst 13 essentially consists, for example, of an aluminum oxide substrate to which CeO2 and Ba(OH)2 or BaCO3 are applied. Platinum and rhodium or palladium, for example, can serve as active components.

Upstream of the storage catalyst 13, the exhaust tract has a branch 14. The branch 14a, in which the storage catalyst 13 is located, ends in an end pipe of the exhaust tract, while the other branch 14b is part of an exhaust gas recirculation device and opens into the intake manifold 5 at the downstream end with respect to the branch. The exhaust gas recirculation device thus recirculates high-pressure gas. The exhaust gas recirculation device can also contain, for example, valves and sensors for monitoring the recirculated exhaust gas. In the branch 14a, preferably upstream of the storage catalyst 13, a turbine can also be provided which drives an exhaust gas turbocharger.

The system 1 also comprises a storage device 15 which is filled with hydrogen. The storage device 15 is coupled to the intake manifold 5 via the injection device 9 in a fluid communicating manner, wherein the injection device 9 can inject the hydrogen into the intake manifold 5 upstream of the inlet 7a. The injection device 9 is an example of a feeding device for feeding the fuel. Furthermore, the storage device 15 is coupled to the exhaust tract upstream of the catalyst 13 via a line 16 in a fluid communicating manner. An end section 16a (injector) of the line 16 has a divergent shape in the direction of outlet 16a1 and thus represents a profile angled with respect to a main flow direction of the line 16. The end section 16a with the outlet 16a1 is an inflow device for the reduction agent within the meaning of the claims.

Furthermore, the system 1 has a control device 17 such as an ECU. The control device 17 receives signals (shown as dashed lines) from numerous sensors arranged in the system 1 and in turn controls actuators and valves arranged in the system 1 via electrical signals (shown as dashed lines).

The system 1 can be used to carry out the method explained above. When the control device 17 receives a start signal to start the internal combustion engine 2, the injection device 9 is activated to inject the hydrogen fuel into the air in the intake manifold 5 in the intake stroke. The combustion of the hydrogen/air mixture in the combustion chamber 3 through ignition by the spark plug 10 delivers power to the crankshaft 12. The combustion product passes as exhaust gas through the outlet 7b into the exhaust tract 6. There it flows through the NOx storage catalyst 13.

The function of the storage catalyst 13 is as follows. In a regular first operating state of the engine 2 (λ>1, combustion of a lean mixture), NO is oxidized on the precious metals, such as platinum, of the catalyst 9 by means of the excess oxygen present to NO2, which is bound to storage components, preferably basic storage components such as Ba(OH)2 or BaCO3, as nitrite and above all nitrate.

The engine 2 can be operated continuously in the first operating state. By burning a lean mixture, the efficiency of the engine 2 can be increased. At the same time, the combustion temperatures can be reduced, which inhibits the formation of nitrogen oxides and thus allows the NOx storage catalyst 13 to store nitrogen oxides over a long period of time. The combustion of the lean mixture is preferably operated continuously, thus over a plurality of cycles of the internal combustion engine. Preferably, a λ of greater than or equal to 1 and less than or equal to 5 is set; depending on the operating point, a λ of greater than or equal to 1.3 and less than or equal to 3.5 is particularly preferred.

If the control device 17 now receives the information that the engine 2 is being operated in idling operation, for example because the motor vehicle in which the system 1 is being used stops at a traffic light, the control device 17 controls the throttle valve 8 and thus reduces the amount of air in the intake manifold 5. At the same time, the control device 17 activates the exhaust gas recirculation device, for example by opening a shut-off valve arranged in the branch 14b and reducing the flow rate of the exhaust gas in the branch 14a. This sets a second operating state in idling operation in which a rich air/hydrogen mixture (λ<1) is burned, as the amount of air is reduced to such an extent that a rich mixture is created with the amount of fuel injected by the injection device 9 at the same mixture calorific value. At the same time, recirculated exhaust gas is fed into the mixture. The air supply is preferably set so that a sub-stoichiometric mixture with the mixture calorific value required at least for idling power is achieved.

On the one hand, a rich air/hydrogen mixture can reduce, preferably completely prevent, the formation of nitrogen oxide due to the complete combustion of oxygen with hydrogen, and on the other hand, it can ensure that unburned hydrogen is fed to the exhaust tract 6 as a reduction agent. This means that the excess hydrogen can be used to regenerate the NOx storage catalyst 13. The recirculated exhaust gas returns inert components of the combustion product from the exhaust tract 6 to the combustion chamber 3. These components no longer take part in the combustion process. This means that the process temperature can be reduced, which inhibits the formation of further nitrogen oxide. This means that the storage catalyst can be regenerated reliably. For this reason, it is also preferred if exhaust gas is recirculated at least temporarily in a transition between the first operating state and the second operating state.

Preferably, the second operating state is set by the control device 17 until the catalyst 13 is fully regenerated.

In a similar way to idling operation, the control device can also set the second operating state during overrun operation of the engine 2. For example, if the control device 17 detects that an overrun mode is present, the control device 17 controls the injection device 9 so that a rich mixture is present in accordance with the amount of air supplied, which can be regulated by the throttle valve 8. Furthermore, exhaust gas recirculation is activated in a similar way to idling operation.

One prerequisite for overrun operation is that the operator (for example a driver) does not request any torque from the combustion engine, that is, the accelerator pedal is not depressed. In order to ensure zero torque despite the fuel feed, the spark plug 10 is activated at a very late stage.

Preferably, ignition takes place in a range from a maximum of 40° before the top dead center of a crankshaft angle to the opening of an exhaust valve, in particular in an angular range of a crankshaft from a maximum of 40° before to a maximum of 360° after the top dead center, further preferably from a maximum of 20° before to a maximum of 360° after the top dead center, again preferably from a maximum of an angle corresponding to a top dead center to a maximum of 360° after the top dead center.

Preferably, the air supply in overrun operation is reduced compared to a working mode (powered by the internal combustion engine), for example by adjusting the throttle valve. This means that only very little hydrogen needs to be supplied in order to set up a rich mixture.

The rich mixture and the late ignition can increase the exhaust gas enthalpy, which ensures a sufficient temperature for regeneration of the catalyst 13. The power generated by the internal combustion engine in overrun operation corresponding to the rich mixture calorific value is less than the dragging power applied to the internal combustion engine. The advantage of burning a rich mixture as a regeneration operation in the overrun phase is that the transition from the lean to the rich mixture range can take place discontinuously and therefore a mixture range around A equal to 1 does not have to be traversed. The formation of nitrogen oxides is generally very high in this range. During the transition to idling operation, a mixture range with high nitrogen oxide formation may occur under certain circumstances if the mixture is continuously transferred from the over-stoichiometric to the under-stoichiometric range.

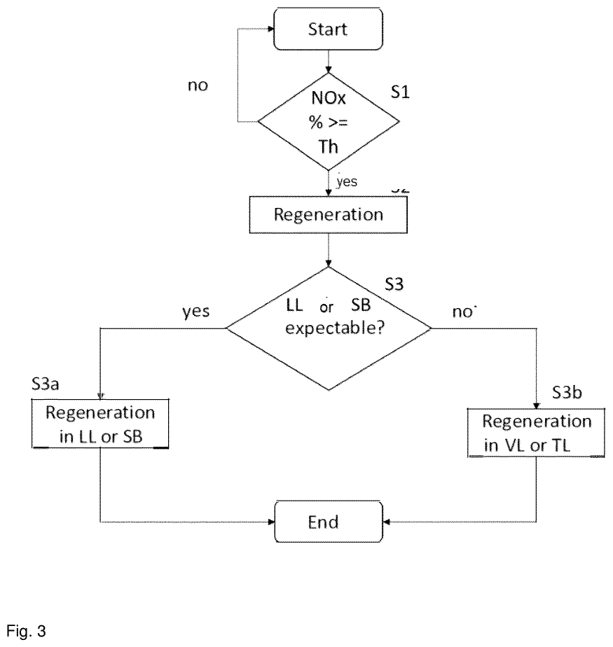

The method described above is summarized by means of FIG. 3. In a step S1, the system 1 continuously monitors the saturation state NOx % of the catalyst 13, wherein known methods, for example by measurement, can be used and/or the saturation state can be modeled. If the control device 17 determines that the saturation state has reached, for example, a predetermined limit value Th greater than 20% or less than 100%, preferably 70-90%, a regeneration is requested in step S2, thus the second operating state is instructed.

In a step S3, a check is made as to whether an idling operation LL or an overrun operation SB can be expected in a predefined time interval. For example, the route profile on which a vehicle with an internal combustion engine is traveling or navigation data can be used. The predefined time interval preferably depends on the limit value Th. If idling or overrun operation can be expected within the specified time interval, regeneration is carried out in one of the two states in step S3a. If it is determined that no idling operation or overrun operation is or will be present, for example, a shut-off valve in the line 16 is released and hydrogen from the hydrogen storage device 15 is fed directly into the exhaust tract 6 via the inflow device 16a, bypassing the combustion chamber 3. In this way, regeneration of the catalyst 13 can also be ensured in the event that an appropriate condition for the combustion of a rich mixture does not occur over a long period of time. In particular, the catalyst 13 can be regenerated at full load VL or TL.

If necessary, the line 16 and the inflow device 16a can also be dispensed with. In this case, the control device 17 can, for example, issue a warning to the user of the internal combustion engine 2 (driver) when the degree of saturation of the catalyst 13 is greater than 20% or less than 100%, preferably 70-90%, that it is necessary to switch to idling operation. The limit value is preferably lower than when the inflow device is present in order to provide sufficient time to switch to overrun or idling operation.

However, the control device 17 as such not according to the invention can also be programmed so that it does not set combustion of a rich mixture under exhaust gas recirculation either in overrun operation or in idling operation. In this case, regeneration in the second operating state can take place solely via the line 16 and the inflow device 16a, wherein a reduction agent is fed directly into the exhaust tract 6. This means that the engine 2 can continue to be operated in the first operating state (lean mixture) while the second operating state is present at the same time. Alternatively or additionally, however, it is also possible, particularly if the fuel is fed directly into the combustion chamber 3 via a feeding device in the engine, to provide the reduction agent as part of the exhaust gas. In this case, the reduction agent can be fed into the combustion chamber 3 and then fed to the exhaust tract 6 after being discharged from the combustion chamber 3. The feed into the combustion chamber 3 preferably takes place after completion of a combustion process, thus when ignition by the spark plug is complete and the energy of the burned mixture does not allow combustion of the reduction agent fed in particular in the exhaust stroke. In particular, the reduction agent is hydrogen and can be supplied via the same feeding device as the burned hydrogen. In this case, a lean mixture can also be burned.

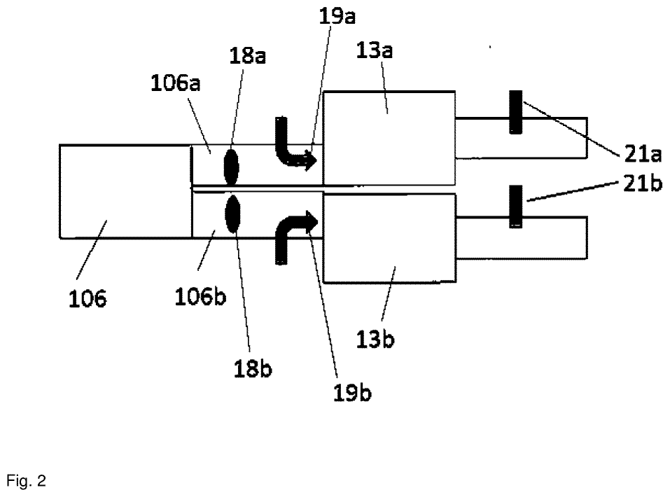

FIG. 2 shows a schematic longitudinal sectional view of a modification of an exhaust tract 106 of the engine.

As shown in FIG. 2, the exhaust tract 106 differs from the above exhaust tract 6 in that it is divided into two exhaust tract sections 106a and 106b, preferably downstream of the branch shown in FIG. 1, which are connected in parallel to each other, for example. Both the exhaust tract section 106a and the exhaust tract section 106b each have a NOx storage catalyst 13a and 13b. Upstream of each of the two catalysts 13a and 13b are throttle valves (throttle devices as defined in the claims) 18a and 18b. Between the throttle valves 18a and 18b and the catalysts 13a and 13b, an inflow device 19a or 19b is further provided in each case, via which a reduction agent for regenerating the catalysts 13a and 13b can be fed into the respective exhaust tract section 106a and 106b, wherein the at least one combustion chamber is bypassed. In other words, each exhaust tract section 106a and 106b comprises an inflow device 19a and 19b upstream of the catalysts 13a and 13b. Each inflow device 19a and 19b preferably comprises an injector. The injector injects the reduction agent (hydrogen) into the exhaust tract section 106a and 106b.

The throttle valves 18a and 18b are variable in terms of their degree of throttling. The opening angle of each throttle valve 18a and 18b can be set individually, thus independently of the other throttle valve. Thus, the amount of exhaust gas flowing to the respective exhaust tract section 106a and 106b can be changed, in particular individually regulated. The inflow devices (injectors) can also be controlled individually so that reduction agents can be supplied separately to each exhaust tract section 106a and 106b. In particular, the amount (mass flow) of reduction agent supplied is controlled individually.

The above modification is advantageous in that the engine can be operated at the optimum operating point and does not have to carry out rich combustion to avoid oxygen and nitrogen oxide components in the exhaust gas. According to the above modification, the efficiency of nitrogen oxide storage and regeneration can be increased. If one (e.g. 13a) of the NOx storage catalysts 13a and 13b in the parallel exhaust tract sections is close to its capacity limit, for example above the predetermined limit value Th, exhaust gas can continue to be stored in the other NOx storage catalyst 13b in the other exhaust tract section 106b, by the throttling device 18a of the exhaust tract section in which the storage catalyst 13a is located, which is operating close to its capacity limit, reducing, preferably completely suppressing, the flow rate supplied for this exhaust tract section. This configuration is particularly effective for regeneration. With only one storage catalyst, either the internal combustion engine must be run rich for regeneration or a considerable amount of reduction agent must be fed separately into the exhaust tract, bypassing at least one combustion chamber. In the latter method, the internal combustion engine can still be operated lean, but a considerable amount of reduction agent (hydrogen) must be supplied to compensate for the oxygen present due to the lean combustion. Only then can regeneration take place with the exclusion of oxygen. In contrast, the present embodiment allows the oxygen supply in the respective exhaust tract section 106a to be reduced by the throttling device 18a, which means that a smaller amount of hydrogen is required compared to only one exhaust tract section as in the first embodiment.

Preferably, the storage catalysts 13a and 13b and the exhaust tract sections 106a and 106b are identically dimensioned. The storage catalysts 13a and 13b connected in parallel and the exhaust tract sections 106a and 106b together are configured in such a way that the nitrogen oxides produced at maximum power can be completely stored in the unthrottled state of all exhaust tract sections, thus when the flow rate is not reduced. In other words, the entire exhaust gas produced at maximum power, possibly minus an exhaust gas recirculation amount, is cleaned of nitrogen oxide when the exhaust tract sections 106a and 106b are fully open.

In this context, the highest increase in efficiency results in the case of two storage catalysts connected in parallel when the combustion engine is operated at a maximum of half the maximum power. Consequently, the flow rates are alternately reduced, in particular completely suppressed, and not reduced at an applied power of up to one times the rate power minus the reciprocal value of the number of exhaust tract sections arranged in parallel (two, reciprocal value: ½) times the rated power.

This is because in this case, the throttle device 18a of an exhaust tract section can be controlled, at least for the regeneration of the storage catalyst 13a arranged therein, in such a way that it completely blocks the exhaust gas supply in this exhaust tract section 106a, at least one of whose storage catalyst 13a is to be regenerated. At the same time, the throttle device 18b in the parallel exhaust tract section 106b is preferably controlled so that it is completely open. The respective flow rates are therefore alternately completely suppressed and not reduced.

In particular preferably, the respective throttle devices 18a and 18b are fully opened and closed alternately during operation of the internal combustion engine when up to half of the maximum power is applied. The ECU 17 controls the throttle valves 18a and 18b as well as the inflow devices 19a and 19b.

However, it is also conceivable to configure at least the storage catalysts arranged in parallel, preferably the entire respective exhaust tract section, in such a way that the flow rate can be completely suppressed at rated power (maximum power) in at least one exhaust tract section. The flow rate can then flow at nominal power through the remaining exhaust tract sections in which the flow rate is not reduced and the storage catalysts arranged therein. This ensures that nitrogen oxide generated even at nominal output is stored in the storage catalysts of the exhaust tract sections that are not reduced. In the case of two parallel exhaust tract sections, each of the exhaust tract sections is preferably configured in such a way that, at rated output, the nitrogen oxides produced can be completely stored in the at least one storage catalyst of the exhaust tract section in which the flow rate is not reduced. This allows the map range in which full regeneration is possible to be extended. The catalysts and exhaust gas train sections are therefore oversized compared to the case in which they together are adapted in such a way that the entire exhaust gas volume can be cleaned in the unthrottled state.

Downstream of the catalysts there are nitrogen oxide sensors 21a and 21b, which detect a nitrogen oxide content in the after-treated exhaust gas and can thus determine the complete saturation or malfunction of the catalysts. If, for example, a nitrogen oxide content is detected downstream of the catalyst 13a, the control device 17 can control the throttle valve 18a so that it is fully closed. At the same time, the other throttle valve 18b is fully opened. The degree of saturation in the catalysts themselves can be measured using known methods. The degree of saturation can also be modeled.

It is also possible to arrange at least one nitrogen oxide sensor upstream of the storage catalysts. This can be done in each of the parallel exhaust tract sections 106a and 106b, preferably upstream of the respective throttle valve and/or in the common exhaust tract 106 upstream of the splitting. In particular, an output of this at least one nitrogen oxide sensor can be used to control the exhaust tract sections arranged in parallel.

The exhaust tract sections, in particular throttle valves and injectors, can thus be controlled on the basis of a signal from the at least one nitrogen oxide sensor upstream or downstream of the catalysts. It is preferred that the throttle valves 18a and 18b are controlled in such a way that when the regeneration limit value of, for example, 80% saturation level is reached in one catalyst 13a, the other catalyst 13b has a distance of at least 20% saturation level to its regeneration limit value. In this way, it can be ensured that the other catalyst 13b has sufficient capacity for further nitrogen oxide when the catalyst 13a is regenerated.

In the modification, the number of exhaust tract sections is not limited to two. Rather, more than two exhaust tract sections can also be provided. In addition, preferred effects are already achieved if only one of the exhaust tract sections upstream of the catalyst has a variable throttle device. This is because the catalyst in question can be kept free of further nitrogen oxide when the capacity limit is reached and can be regenerated independently of the other parallel catalysts. Preferably, the catalysts arranged in parallel and/or the exhaust tract sections are each adapted to a size ratio of 1:1 in terms of their storage volume or cross-sectional area. This allows a particularly high increase in efficiency.

A rich combustion mixture can also be burned for regeneration.

Similarly, in the above embodiments, a plurality of combustion chambers can be provided instead of one combustion chamber.

As already mentioned, the type of mixture formation is not important. This can take place inside or outside the combustion chamber.

Instead of the angled profile in the end section 16a of the line 16, a turning device with screw flights can also be provided, along which the fluid is forced to flow. The main flow direction of the outlet 16a1 can also be inclined with respect to the main flow direction of the exhaust tract or exhaust tract section. It is not necessary to provide an angled profile. The inclined arrangement imposes a rotational component on the flow.

It is preferred if the exhaust gas is recirculated upstream of the at least one storage catalyst, however, the exhaust gas recirculation may also take place downstream of the at least one storage catalyst.

Unless the present disclosure teaches otherwise, “at least” also includes the respective entirety. The above system 1 is preferably used in a motor vehicle and is embedded therein. The engine 2 is preferably a converted conventional diesel engine, particularly preferably a diesel engine of a commercial vehicle such as a truck. The system further provides a hydrogen tank as a fuel storage device 15 instead of a diesel tank. For the system 1 and the above method, an internal combustion engine according to the diesel principle including a NOx storage catalyst is thus preferably used, which is correspondingly large and thus ensures long storage times for the hydrogen engine.

A further aspect of the present invention is thus directed to a conversion method of an existing diesel-powered system, which may be implemented in a motor vehicle, for example, wherein the storage device for the fuel is replaced by a hydrogen storage device and the direct injection device is replaced by a spark plug. It is also conceivable to provide a feeding device for feeding the hydrogen into the combustion chamber, preferably on the cylinder head. If not available, a throttle valve can also be added. Furthermore, the control device is programmed to carry out the above method.

The invention also relates to a use of an internal combustion engine used in a diesel-powered system, which is provided with at least one storage catalyst, and/or the at least one storage catalyst in a system described in this disclosure and/or for a method described in this system.

### LIST OF REFERENCE SIGNS

1 system
2 internal combustion engine
3 combustion chamber
5 intake manifold
6, 106 exhaust tract
106a,106b exhaust tract sections
7a, 7b inlet, outlet
8 throttle valve
9 injection device
10 spark plug
11 piston
12 crankshaft
13, 13a, 13b NOx storage catalyst/NOx storage catalyst
14 branch
14a, 14b branch
15 storage device
16 line
16a, 19a, 19b inflow device
16a1 outlet of the end section (of the inflow device)
17 control device
18a, 18b throttle device/throttle valve
21a, 21b nitrogen oxide sensor

1.-15. (canceled)

16. A method for operating an internal combustion engine, wherein the internal combustion engine comprises:
at least one combustion chamber in which a fuel is at least partially burned with ambient air,
an exhaust tract that is coupled to an outlet side of the at least one combustion chamber in a fluid communicating manner,
wherein hydrogen is used as fuel for the internal combustion engine,
wherein the internal combustion engine also has at least one NOx storage catalyst and an exhaust gas discharged from the at least one combustion chamber into the exhaust tract at least partially flows through the at least one NOx storage catalyst,
wherein a lean air/hydrogen mixture is burned in the at least one combustion chamber in a first operating state,
wherein the NOx storage catalyst is regenerated in a second operating state, and
a rich air/hydrogen mixture is burned in the at least one combustion chamber in the second operating state,
wherein the second operating state is set in an idling operation of the internal combustion engine and/or the second operating state is set in an overrun operation of the internal combustion engine.

17. The method for operating an internal combustion engine according to claim 16, wherein the internal combustion engine further comprises an exhaust gas recirculation device, via which exhaust gas is returned from the exhaust tract to the combustion chamber.

18. The method for operating an internal combustion engine according to claim 16, wherein, in the second operating state, exhaust gas is recirculated into the at least one combustion chamber via the exhaust gas recirculation device.

19. A method for operating an internal combustion engine, wherein the internal combustion engine comprises:
at least one combustion chamber in which a fuel is at least partially burned with ambient air,
an exhaust tract which is coupled to an outlet side of the at least one combustion chamber in a fluid communicating manner,
wherein hydrogen is used as fuel for the internal combustion engine,
wherein the exhaust tract has a plurality of exhaust tract sections connected in parallel to one another, wherein at least two of the plurality of exhaust tract sections each have at least one NOx storage catalyst through which at least a portion of an exhaust gas discharged from the at least one combustion chamber into the exhaust tract flows at least temporarily,
wherein the flow rate through the at least one NOx storage catalyst in at least one of the exhaust tract sections is at least temporarily changed,
wherein the flow rate of the exhaust gas in a plurality of the exhaust tract sections, each exhaust tract section comprising the at least one NOx storage catalyst, is changed independently of each other by a throttling device variable in terms of its degree of throttling and respectively arranged upstream of the at least one NOx storage catalyst in the plurality the exhaust tract sections, and
wherein a reduction agent for reducing the nitrogen oxides stored in the NOx storage catalyst is fed into the plurality of exhaust tract sections between the respective at least one NOx storage catalyst and the variable throttle device.

20. The method according to claim 19, wherein the flow rate in at least one of the exhaust tract sections is reduced for the regeneration of the at least one NOx storage catalyst.

21. The method according to claim 19, wherein a reduction agent for reducing the nitrogen oxides stored in the NOx storage catalyst is at least temporarily fed into at least one exhaust tract section upstream of the at least one NOx storage catalyst or into the at least one NOx storage catalyst separately.

22. The method according to claim 19, wherein at least two of the exhaust tract sections are regenerated alternately at least temporarily.

23. A control device configured to carry out a method according to claim 16.

24. A system for carrying out a method according to claim 16, comprising:
an internal combustion engine comprising:
at least one combustion chamber in which a fuel is at least partially burnable with ambient air,
an exhaust tract which is coupled to an outlet side of the at least one combustion chamber in a fluid communicating manner, and
also at least one NOx storage catalyst and an exhaust gas discharged from the at least one combustion chamber into the exhaust tract can at least partially flow through the at least one NOx storage catalyst; and
a storage device for hydrogen, which is coupled to the internal combustion engine in a fluid communicating manner, and
a control device configured to carry out the method, and
wherein preferably the internal combustion engine also has at least one inflow device via which a reduction agent can be fed into the combustion chamber or into the exhaust tract.

25. The system according to claim 24,
wherein the exhaust tract comprises a plurality of exhaust tract sections connected in parallel to one another, wherein at least two of the plurality of exhaust tract sections each have at least one NOx storage catalyst through which at least a portion of an exhaust gas discharged from the at least one combustion chamber into the exhaust tract is flowable at least temporarily,
wherein a throttle device variable in terms of its degree of throttling is respectively arranged in a plurality of the plurality of exhaust tract sections arranged parallel to one another upstream of the at least one NOx storage catalyst, the variable throttle device being individually controllable to regulate the exhaust gas amount in the respective exhaust tract section, and
the plurality of exhaust tract sections respectively comprise an inflow device for feeding in a reduction agent for reducing the nitrogen oxides stored in the NOx storage catalyst between the respective at least one NOx storage catalyst and the variable throttle device.

26. (canceled)

27. (canceled)
